(19) United States
(12) Patent Application Publication
(10) Pub. No.: US 2015/0220442 A1
(43) Pub. Date: Aug. 6, 2015

(54) PRIORITIZING SHARED MEMORY BASED ON QUALITY OF SERVICE

(71) Applicant: Bluedata Software, Inc., Mountain View, CA (US)

(72) Inventors: Thomas A. Phelan, San Francisco, CA (US); Michael J. Moretti, Saratoga, CA (US); Gunaseelan Lakshminarayanan, Cupertino, CA (US); Ramaswami Kishore, San Francisco, CA (US)

(21) Appl. No.: 14/483,661

(22) Filed: Sep. 11, 2014

Related U.S. Application Data
(60) Provisional application No. 61/935,524, filed on Feb. 4, 2014.

(51) Int. Cl. G06F 12/08; G06F 13/16

(52) U.S. Cl. CPC G06F 12/0871; G06F 12/0875; G06F 13/1663; G06F 13/1626; G06F 2212/452; G06F 2212/314

(57) ABSTRACT

Systems, methods, and software described herein facilitate a cache service that allocates shared memory in a data processing cluster based on quality of service. In one example, a method for operating a cache service includes identifying one or more jobs to be processed in a cluster environment. The method further provides determining a quality of service for the one or more jobs and allocating shared memory for the one or more jobs based on the quality of service.

### RELATED APPLICATIONS

This application is related to and claims priority to U.S. Provisional Patent Application No. 61/935,524, entitled “PRIORITIZING SHARED MEMORY BASED ON QUALITY OF SERVICE,” filed on Feb. 4, 2014, and which is hereby incorporated by reference in its entirety.

### TECHNICAL FIELD

Aspects of the disclosure are related to computing hardware and software technology, and in particular to allocating shared memory in virtual machines based on quality of service.

### TECHNICAL BACKGROUND

An increasing number of data-intensive distributed applications are being developed to serve various needs, such as processing very large data sets that generally cannot be handled by a single computer. Instead, clusters of computers are employed to distribute various tasks or jobs, such as organizing and accessing the data and performing related operations with respect to the data. Various applications and frameworks have been developed to interact with such large data sets, including Hive, HBase, Hadoop, Amazon S3, and CloudStore, among others.

At the same time, virtualization techniques have gained popularity and are now commonplace in data centers and other environments in which it is useful to increase the efficiency with which computing resources are used. In a virtualized environment, one or more virtual machines are instantiated on an underlying computer (or another virtual machine) and share the resources of the underlying computer. However, deploying data-intensive distributed applications across clusters of virtual machines has generally proven impractical due to the latency associated with feeding large data sets to the applications. Accordingly, in some examples, memory caches within the virtual machines may be used to temporarily store data that is accessed by the data processes within the virtual machine.

### OVERVIEW

Provided herein are systems, methods, and software to facilitate the allocation of shared memory in a data processing cluster based on quality of service. In one example, a method of providing shared memory in a data processing cluster environment includes identifying one or more jobs to be processed in the data processing cluster environment. The method further includes determining a quality of service for each of the one or more jobs, and allocating the shared memory for each of the one or more jobs in the data processing cluster environment based on the quality of service for each of the one or more jobs.

In another example, a computer apparatus to manage shared memory in a data processing cluster environment includes processing instructions that direct a computing system to identify one or more jobs to be processed in the data processing cluster environment. The processing instructions further direct the computing system to determine a quality of service for each of the one or more jobs, and allocate the shared memory for each of the one or more jobs in the data processing cluster environment based on the quality of service for each of the one or more jobs. The computer apparatus also includes one or more non-transitory computer readable media that store the processing instructions.

This Overview is provided to introduce a selection of concepts in a simplified form that are further described below in the Technical Disclosure. It should be understood that this Overview is not intended to identify key features or essential features of the claimed subject matter, nor is it intended to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a cluster environment that allocates memory based on quality of service.

FIG. 2 illustrates a method of allocating shared memory based on quality of service.

FIG. 3 illustrates an overview of operating a system to allocate memory based on quality of service.

FIG. 4 illustrates a computing system for allocating memory based on quality of service.

FIG. 5A illustrates a memory system for allocating shared memory based on quality of service.

FIG. 5B illustrates a memory system for allocating shared memory based on quality of service.

FIG. 6 illustrates an overview of allocating shared memory based on quality of service.

FIG. 7 illustrates an overview of allocating shared memory based on quality of service.

FIG. 8 illustrates a system that allocates memory based on quality of service.

FIG. 9 illustrates an overview of allocating shared memory to jobs within a data processing cluster environment.

### TECHNICAL DISCLOSURE

Various implementations described herein provide improved cache sharing for large data sets based on quality of service. In particular, applications and frameworks have been developed to process vast amounts of data from storage volumes using one or more processing systems. These processing systems may include real processing systems, such as server computers, desktop computers, and the like, as well as virtual machines within these real or host processing systems.

In at least one implementation, one or more virtual machines are instantiated within a host environment. The virtual machines may be instantiated by a hypervisor running in the host environment, which may run with or without an operating system beneath it. For example, in some implementations, the hypervisor may be implemented at a layer above the host operating system, while in other implementations the hypervisor may be integrated with the operating system. Other hypervisor configurations are possible and may be considered within the scope of the present disclosure.

The virtual machines may include various guest elements or processes, such as a guest operating system and its components, guest applications, and the like, that consume and execute on data. The virtual machines may also include virtual representations of various computing components, such as guest memory, a guest storage system, and a guest processor.

In operation, a guest element running within the virtual machine, such as an application or framework for working with large data sets, may require data for processing. This application or framework is used to take data in from one or more storage volumes, and process the data in parallel with one or more other virtual or real machines. In some instances, a guest element, such as Hadoop or other similar framework within the virtual machines, may process data using a special file system that communicates with the other virtual machines that are working on the same data. This special file system may manage the data in such a way that the guest element nodes recognize the closest data source for the process, and can compensate for data loss or malfunction by moving to another data source when necessary.

In the present example, a cluster of virtual machines may operate on a plurality of data tasks or jobs. These virtual machines may include an operating system, software, drivers, and other elements to process the data. Further, the virtual machines may be in communication with a distributed cache service that brings in the data from the overarching dataset. This cache service is configured to allow the virtual machine to associate or map the guest memory to the host memory. As a result, the guest virtual machine may read data directly from the “shared” memory of the host computing system to process the necessary data.

In addition to associating host memory with guest memory, the cache service, or an alternative allocation service within the cluster environment, may be able to adjust the size of the shared memory based on the quality of service for each of the particular tasks. For example, a first virtual machine may be processing a first task that has a higher priority than a second task operating on a second virtual machine. Accordingly, the cache or allocation service may be used to assign a larger amount of shared memory for the first task as opposed to the second task. In another example, if two tasks or jobs are being performed within the same virtual machine, the cache or allocation service may also provide shared memory based on the quality of service to the individual jobs within the same machine. As a result, one of the tasks may be reserved a greater amount of memory than the other task.

In still another instance, a host computing system may be configured with a plurality of virtual machines with different amounts of shared memory. As new jobs are identified, the cache service or some other allocation service may assign the jobs to the virtual machines based on a quality of service. Accordingly, a job with a higher quality of service may be assigned to the virtual machines with the most shared memory, and the jobs with the lower quality of service may be assigned to the virtual machines with a smaller amount of shared memory.

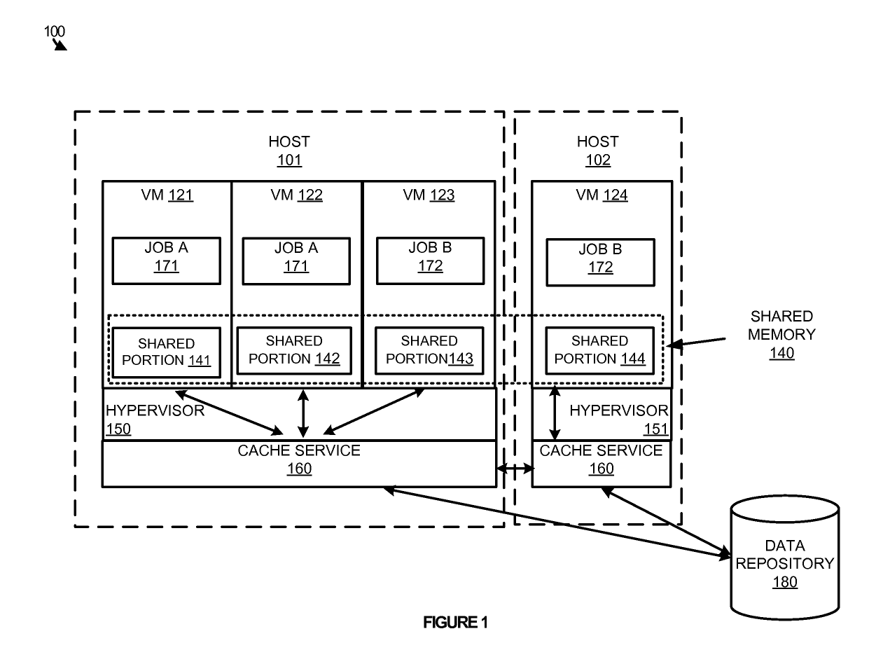

Referring now to FIG. 1, FIG. 1 illustrates a cluster environment 100 that allocates shared memory based on quality of service. Cluster environment 100 includes hosts 101-102, virtual machines 121-124, hypervisors 150-151, cache service 160, and data repository 180. Virtual machines 121-124 further include jobs 171-172 and shared memory portions 141-144 that are portions or segments of shared memory 140.

In operation, hypervisors 150-151 may be used to instantiate virtual machines 121-124 on hosts 101-102. Virtual machines 121-124 may be used in a distributive manner to process data and may include various guest elements, such as a guest operating system and its components, guest applications, and the like. The virtual machines may also include virtual representations of computing components, such as guest memory, a guest storage system, and a guest processor.

As illustrated in cluster environment 100, each of the virtual machines may be assigned a job, such as jobs 171-172. These jobs use distributed frameworks, such as Hadoop or other distributed data processing frameworks, on the virtual machines to support data-intensive distributed applications, and support parallel running of applications on large clusters of commodity hardware. During the execution of jobs 171-172 on virtual machines 121-124, the data processing framework on the virtual machines may require new data from data repository 180. Accordingly, to gather the new data necessary for data processing, cache service 160 is used to access the data and place the data within shared memory 140. Shared memory 140, illustrated individually within virtual machines 121-124 as shared memory portions 141-144, allows cache service 160 to access data within data repository 180, and provide the data into a memory space that is accessible by processes on both the host and the virtual machine. Thus, when new data is required, cache service 160 may place the data in the appropriate shared portion for the virtual machine, which allows a process within the virtual machine to access the data.

Here, shared memory portions 141-144 may be allocated or assigned to the virtual machines with different memory sizes for the processes within the virtual machine. To manage this allocation of shared memory, a quality of service determination may be made by the cache service 160 or a separate allocation service for each of the jobs that are to be initiated in cluster environment 100. For example, job B 172 may have a higher quality of service than job A 171. As a result, when the jobs are assigned to the various virtual machines, job B 172 may be assigned to the virtual machines with larger amounts of shared memory in their shared portions. This increase in the amount of shared memory, or cache memory in the data processing context, may allow job B 172 to complete at a faster rate than job A 171.

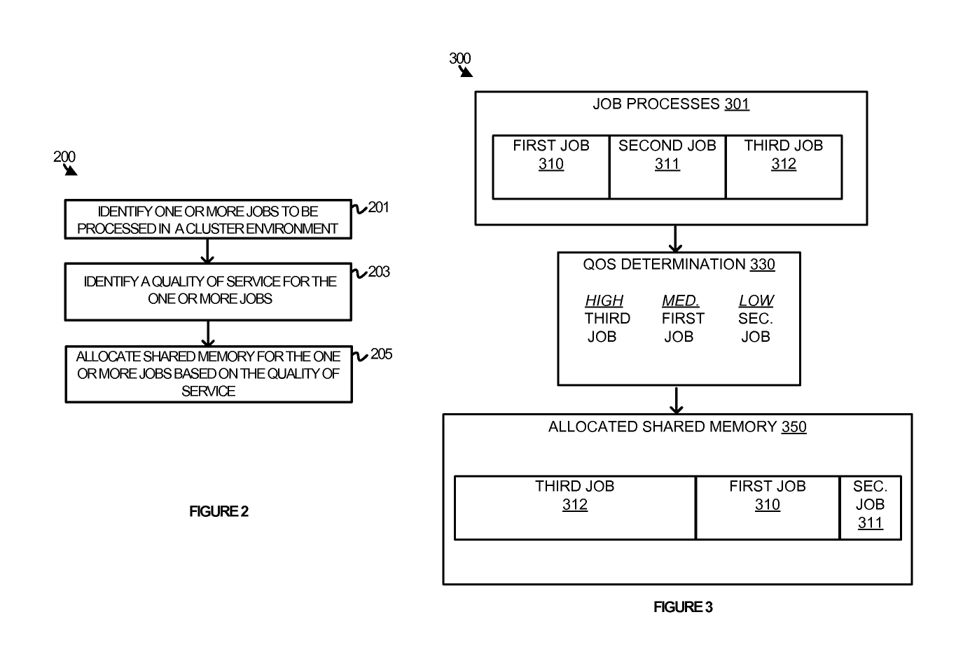

To further illustrate allocation of shared memory, FIG. 2 is included. FIG. 2 illustrates a method 200 of allocating shared memory based on quality of service. Method 200 includes identifying one or more jobs to be processed in a cluster environment (201). This cluster environment comprises a plurality of virtual machines executing on one or more host computing systems. Once the jobs are identified, the method further includes identifying a quality of service for each of the one or more jobs (203). This quality of service may be based on a variety of factors including the amount paid by the end consumer, a delegation of priority by an administrator, a determination based on the size of the data, or any other quality of service factor. Based on the quality of service, the method allocates shared memory for each of the one or more jobs (205).

Referring back to FIG. 1 as an example, cache service 160 or some other memory allocation system within the cluster environment may identify that jobs 171-172 are to be processed in cluster environment 100. Once identified, a quality of service determination is made for the jobs based on the aforementioned variety of factors. Based on the quality of service, the jobs may be allocated shared memory in cluster environment 100. For instance, job B 172 may have a higher priority than job A 171. As a result, a larger amount of shared memory 140 may be allocated to job B 172 as compared to job A 171. This allocation of shared memory may be accomplished by assigning the jobs to particular virtual machines pre-assigned with different sized shared memory portions, assigning the jobs to any available virtual machines and dynamically adjusting the size of the shared memory portions, or any other similar method for allocating shared memory.

FIG. 3 illustrates an overview 300 for allocating memory based on quality of service. Overview 300 includes first job 310, second job 311, and third job 312 as a part of job processes 301. In operation, jobs 310-312 may be initialized to operate in a data cluster that contains a plurality of virtual machines on one or more physical computing devices. Upon initiation, a distributed cache service or some other quality of service system, which may reside on the host computing devices, will identify the jobs and make quality of service determination 330.

In the present example, the quality of service provides third job 312 the highest priority, first job 310 the second highest priority, and second job 311 the lowest priority. Although three levels of priority are illustrated in the example, it should be understood that any number of levels might be included.

Once the quality of service is determined, the jobs are implemented in the virtual machine cluster with shared memory based on the quality of service. Accordingly, as illustrated in allocated shared memory 350, third job 312 receives the largest amount of shared memory followed by first job 310 and second job 311. In some examples, the quality of service determination may be made for each of the virtual machines associated with a particular job. Thus, the amount of shared memory allocated for the jobs may be different for each of the nodes in the processing cluster. In other instances, the virtual machines may be provisioned as groups with different levels of shared memory. Accordingly, a job with a high priority might be assigned to virtual machines with the highest level of shared memory. In contrast, a job with low priority might be assigned to the virtual machines with the lowest amount of shared memory.

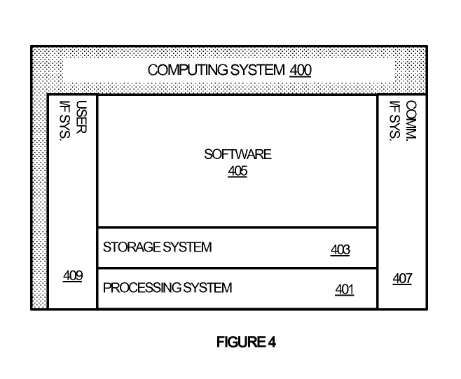

FIG. 4 illustrates computing system 400 that may be employed in any computing apparatus, system, or device, or collections thereof, to suitably allocate shared memory in cluster environment 100, as well as process 200 and overview 300, or variations thereof. In some examples, computing system 400 may represent the cache service described in FIG. 1, however, it should be understood that computing system 400 may represent any control system capable of allocating shared memory for jobs in a data processing cluster. Computing system 400 may be employed in, for example, server computers, cloud computing platforms, data centers, any physical or virtual computing machine, and any variation or combination thereof. In addition, computing system 400 may be employed in desktop computers, laptop computers, or the like.

Computing system 400 includes processing system 401, storage system 403, software 405, communication interface system 407, and user interface system 409. Processing system 401 is operatively coupled with storage system 403, communication interface system 407, and user interface system 409. Processing system 401 loads and executes software 405 from storage system 403. When executed by processing system 401, software 405 directs processing system 401 to operate as described herein to provide shared memory to one or more distributed processing jobs. Computing system 400 may optionally include additional devices, features, or functionality not discussed here for purposes of brevity.

Referring still to FIG. 4, processing system 401 may comprise a microprocessor and other circuitry that retrieves and executes software 405 from storage system 403. Processing system 401 may be implemented within a single processing device, but may also be distributed across multiple processing devices or sub-systems that cooperate in executing program instructions. Examples of processing system 401 include general-purpose central processing units, application specific processors, and logic devices, as well as any other type of processing device, combinations, or variation.

Storage system 403 may comprise any computer readable storage media readable by processing system 401 and capable of storing software 405. Storage system 403 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal.

In addition to storage media, in some implementations storage system 403 may also include communication media over which software 405 may be communicated internally or externally. Storage system 403 may be implemented as a single storage device, but may also be implemented across multiple storage devices or sub-systems co-located or distributed relative to each other. Storage system 403 may comprise additional elements, such as a controller, capable of communicating with processing system 401 or possibly other systems.

Software 405 may be implemented in program or processing instructions and among other functions may, when executed by processing system 401, direct processing system 401 to operate as described herein by FIGS. 1-3. In particular, the program instructions may include various components or modules that cooperate or otherwise interact to carry out the allocating of shared memory as described in FIGS. 1-3. The various components or modules may be embodied in compiled or interpreted instructions or in some other variation or combination of instructions. The various components or modules may be executed in a synchronous or asynchronous manner, in a serial or in parallel, in a single threaded environment or multi-threaded, or in accordance with any other suitable execution paradigm, variation, or combination thereof. Software 405 may include additional processes, programs, or components, such as operating system software, hypervisor software, or other application software. Software 405 may also comprise firmware or some other form of machine-readable processing instructions executable by processing system 401.

For example, if the computer-storage media are implemented as semiconductor-based memory, software 405 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 400 is generally intended to represent a system on which software 405 may be deployed and executed in order to implement FIGS. 1-3 (or variations thereof). However, computing system 400 may also be suitable for any computing system on which software 405 may be staged and from where software 405 may be distributed, transported, downloaded, or otherwise provided to yet another computing system for deployment and execution, or yet additional distribution.

In one example, software 405 directs computing system 400 to identify one or more job processes that are to be executed in a data processing cluster. This cluster may comprise a plurality of virtual machines that are executed by one or more host computing devices. Once the job processes are identified, computing system 400 is configured to determine a quality of service for the jobs. This quality of service determination may be based on a variety of factors, including the amount paid by the end consumer, a delegation of priority by an administrator, the size of the data, or any other quality of service factor.

In response to the quality of service determination, computing system 400 is configured to allocate shared memory that is accessible by the host and virtual machines of the processing cluster. Shared memory allows the applications within the virtual machine to access data directly from host memory, rather than the memory associated with just the virtual machine. As a result, data may be placed in the shared memory by the host computing system, but accessed by the virtual machine via mapping or association.

In general, software 405 may, when loaded into processing system 401 and executed, transform a suitable apparatus, system, or device employing computing system 400 overall from a general-purpose computing system into a special-purpose computing system, customized to facilitate a cache service that allocates shared memory based on quality of service. Indeed, encoding software 405 on storage system 403 may transform the physical structure of storage system 403. The specific transformation of the physical structure may depend on various factors in different implementations of this description. Examples of such factors may include, but are not limited to, the technology used to implement the storage media of storage system 403 and whether the computer-storage media are characterized as primary or secondary storage, as well as other factors.

Communication interface system 407 may include communication connections and devices that allow for communication with other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface system 409, which is optional, may include a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 409. In some cases, the input and output devices may be combined in a single device, such as a display capable of displaying images and receiving touch gestures. The aforementioned user input and output devices are well known in the art and need not be discussed at length here. User interface system 409 may also include associated user interface software executable by processing system 401 in support of the various user input and output devices discussed above. Separately or in conjunction with each other and other hardware and software elements, the user interface software and devices may support a graphical user interface, a natural user interface, or any other suitable type of user interface.

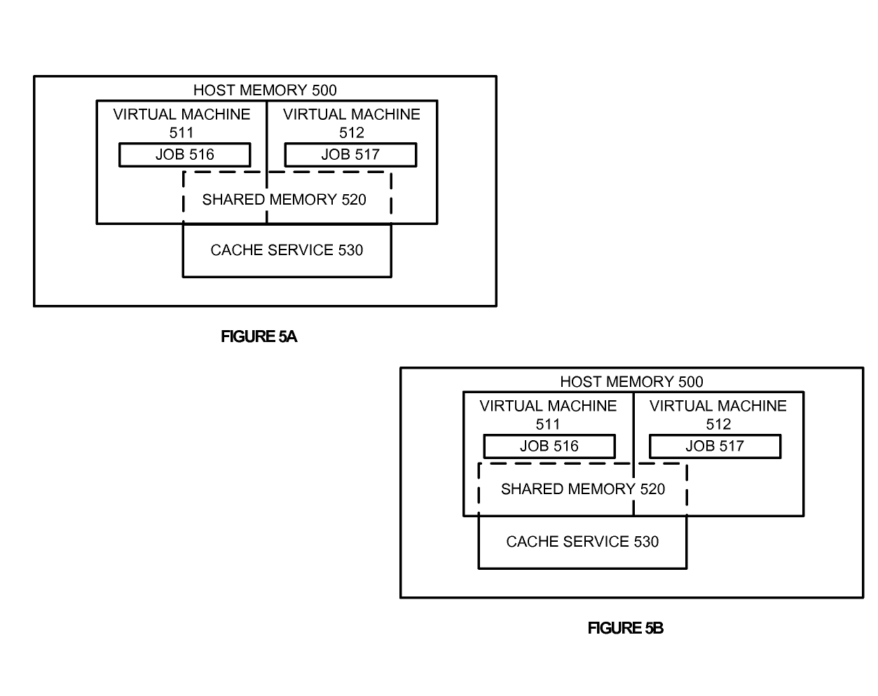

Turning now to FIGS. 5A and 5B, which illustrate a memory system for allocating shared memory based on quality of service. FIGS. 5A and 5B include host memory 500, virtual machines 511-512, jobs 516-517, shared memory 520, and cache service 530. Virtual machines 511-512 are used to process data intensive jobs 516-517 using various applications and frameworks. These frameworks may include Hive, HBase, Hadoop, Amazon S3, and CloudStore, among others.

In operation, cache service 530 is configured to provide data from a data repository for processing by virtual machines 511-512. To accomplish this task, cache service 530 identifies and gathers the data from the appropriate data repository, such as data repository 180, and provides the data in shared memory 520 for processing by the corresponding virtual machine. Shared memory 520 allows the applications within the virtual machine to access data directly from memory associated with the host, rather than the memory associated with just the virtual machine. As a result of the shared or overlapping memory, data may be placed in the shared memory by the host computing system, but accessed by the virtual machine via mapping or association.

In the present example, FIG. 5A illustrates an example where job 517 has a higher priority or quality of service than job 516. As a result, a greater amount of memory is provided, using the cache service or some other allocation service, to the processes of virtual machine 512 than virtual machine 511. In contrast, FIG. 5B illustrates an example where job 516 has a higher quality of service than job 517. Accordingly, a larger amount of shared memory 520 is allocated for virtual machine 511 as opposed to virtual machine 512.

Although illustrated as a set size in the present example, it should be understood that an administrator or some other controller might dynamically adjust the size of shared memory 520 to provide more memory to the individual virtual machines. Further, in some instances, shared memory 520 may dynamically adjust based on changes or additions to the jobs within the system. For example, job 517 may require most of the shared memory initially, but may be allocated less over time if other jobs are given a higher quality of service.

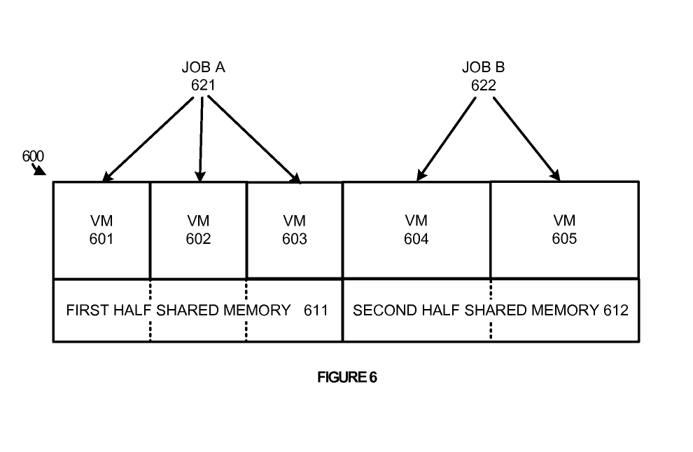

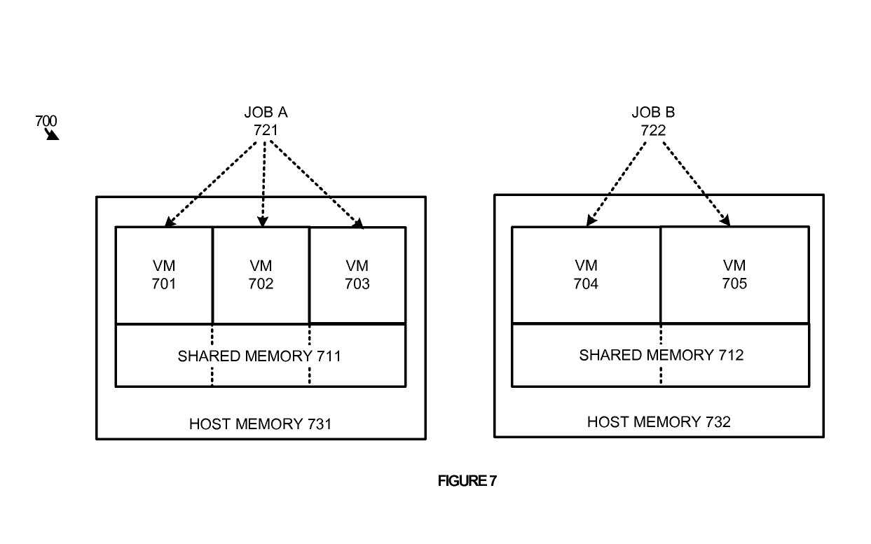

FIG. 6 illustrates an overview of allocating shared memory based on quality of service according to another example. FIG. 6 includes memory 600, virtual machines 601-605, first shared memory 611, second shared memory 612, job A 621, and job B 622. In operation, a host computing system may be initiated with virtual machines 601-605. Each of the virtual machines may include frameworks and other applications that allow the virtual machines to process large data operations. Once the virtual machines are configured, jobs may be allocated to the machines for data processing.

In the present example, job A 621 and job B 622 are to be allocated to the virtual machines based on a quality of service. As a result, one job may be given a larger amount of shared memory than the other job. Here, job B 622 has been allocated a higher priority than job A 621. Accordingly, job B 622 is assigned to virtual machines 604-605, which have access to a larger amount of shared memory per virtual machine. This larger amount of shared memory per virtual machine may allow the processes of job B to process more efficiently and faster than the processes in virtual machines 601-603.

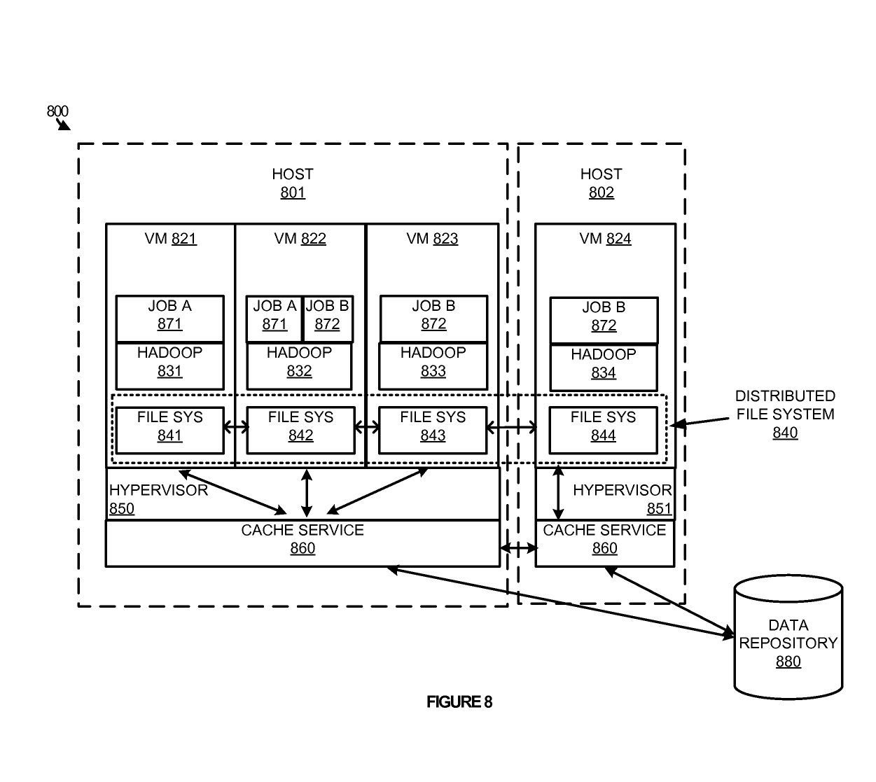

Turning to FIG. 7, FIG. 7 illustrates an overview 700 of allocating shared memory to jobs based on quality of service. Overview 700 includes virtual machines 701-705, shared memory 711-712, host memory 731-732, and jobs 721-722. In operation, shared memory 711-712 is provided to virtual machines 701-705 to allow a process on the host machine to access the same data locations as processes within the virtual machines. Accordingly, if data were required by the virtual machines, the process on the host could gather the data, and place the data within a shared memory location with the virtual machine.

In the present example, shared memory 711 and shared memory 712 are of the same size, but are located on separate host computing systems. As such, one host computing system, represented in FIG. 7 with host memory 731, includes three virtual machines. In contrast, the second host computing system, represented in FIG. 7 with host memory 732, includes only two virtual machines. Accordingly, in the present example, each of the virtual machines included in host memory 732 has a larger portion of shared memory than the virtual machines in host memory 731.

Once the virtual machines are allocated their amount of shared memory, jobs may be allocated to the virtual machines, using a cache or allocation service, based on quality of service. For example, job B 722 may have a higher quality of service than job A 721. As a result, job B 722 may be allocated virtual machines 704-705 with the larger amount of cache memory than virtual machines 701-703. Although illustrated in the present example using two host computing systems, it should be understood that a data processing cluster might contain any number of hosts and virtual machines. Further, although the virtual machines on each of the hosts are illustrated with an equal amount of shared memory, it should be understood that the virtual machines on each of the hosts may each have access to different amounts of shared memory. For example, virtual machines 701-703 may each be allocated different amounts of shared memory in some examples. As a result, the amount of data that may be cached for each of the virtual machines may be different, although the virtual machines are located on the same host computing system.

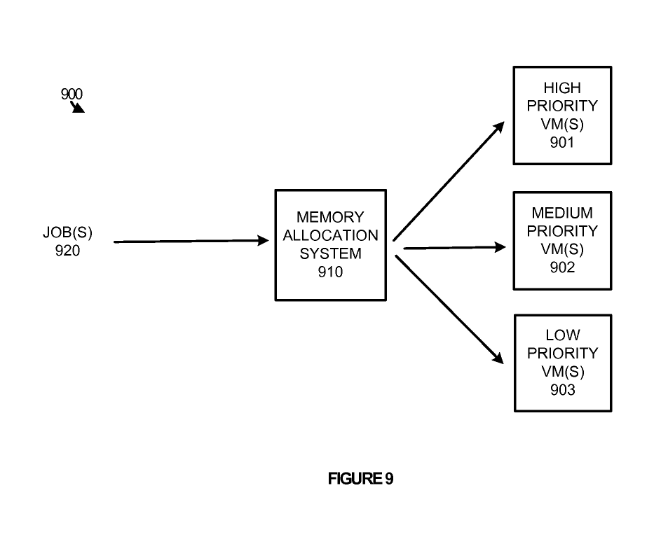

Referring now to FIG. 8, FIG. 8 illustrates a system 800 that allocates shared memory based on quality of service. FIG. 8 is an example of distributed data processing cluster using Hadoop, however, it should be understood that any other distributed data processing frameworks may be employed with quality of service shared memory allocation. System 800 includes hosts 801-802, virtual machines 821-824, hypervisors 850-851, cache service 860, and data repository 880. Virtual machines 821-824 further include Hadoop elements 831-834, and file systems 841-844 as part of distributed file system 840. Cache service 860 is used to communicate with data repository 880, which may be located within the hosts or externally from the hosts, to help supply data to virtual machines 821-824.

In operation, hypervisors 850-851 may be used to instantiate virtual machines 821-824 on hosts 801-802. Virtual machines 821-824 are used to process large amounts of data and may include various guest elements, such as a guest operating system and its components, guest applications, and the like. The virtual machines may also include virtual representations of computing components, such as guest memory, a guest storage system, and a guest processor.

Within virtual machines 821-824, Hadoop elements 831-834 are used to process large amounts of data from data repository 880. Hadoop elements 831-834 are used to support data-intensive distributed applications, and support parallel running of applications on large clusters of commodity hardware. Hadoop elements 831-834 may include the Hadoop open source framework, but may also include Hive, HBase, Amazon S3, and CloudStore, among others.

During execution on the plurality of virtual machines, Hadoop elements 831-834 may require new data for processing job A 871 and job B 872. These jobs represent analysis to be done by the various Hadoop elements, including identifying the number of occurrences that something happens in a data set, where something happens in the data set, amongst other possible analysis. Typically, using frameworks like Hadoop allows the jobs to be spread out across various physical machines and virtual computing elements on the physical machines. By spreading out the workload, it not only reduces the amount of work that each processing element must endure, but also accelerates the result to the data query.

In some examples, users of a data analysis cluster may prefer to further adjust the prioritization of data processing based on a quality of service. Referring again to FIG. 8, Hadoop elements 831-834 on virtual machines 821-824 may have shared allocated memory from hosts 801-802. As a result, when cache service 860 gathers data from data repository 880 using distributed file system 840, the data is placed in shared memory that is accessible by the host and the virtual machine. In the present instance, the shared memory is allocated by the cache service based on the quality of service for the specific job or task, however, it should be understood that the allocation may be done by a separate allocation system or service in some occurrences.

As an illustrative example, job A 871 may have a higher priority level than job B 872. This priority level may be based on a variety of factors, including the amount paid by the end consumer, a delegation of priority by an administrator, a determination based on the size of the data, or any other quality of service factor. Once the priority for the job is determined, cache service 860 may assign the shared memory for the jobs accordingly. This shared memory allows data to be placed in memory using the host, but accessed by the virtual machine using mapping or some other method.

Although the present example provides four virtual machines to process jobs 871-872, it should be understood that the jobs 871-872 could be processed using any number of virtual or real machines with Hadoop or other similar data frameworks. Further, jobs 871-872 may be co-located on the same virtual machines in some instances, but may also be assigned to separate virtual machines in other examples. Moreover, although system 800 includes the processing of two jobs, it should be understood that any number of jobs might be processed in system 800.

FIG. 9 illustrates an overview 900 of allocating shared memory to jobs within a data processing cluster environment. Overview 900 includes virtual machines 901-903, memory allocation system 910, and jobs 920. Memory allocation system 910 may comprise the cache service described in FIGS. 1-8, however, it should be understood that memory allocation system 910 may comprise any other system capable of allocating memory for processing jobs.

As illustrated in the present example, memory allocation system 901 can assign jobs to varying levels of virtual machine priority. These virtual machine priority levels may be based on the amount of shared memory allocated for the virtual machines. For example, high priority virtual machines 901 may have a larger amount of shared memory than medium priority virtual machines 902 and low priority virtual machines 903. Accordingly, the jobs that are assigned to high priority virtual machines 901 may process faster and more efficiently due to the increase in shared memory available to the processes within the virtual machine.

After virtual machines 901-903 are allocated the proper amount of shared memory, allocations system 910 may identify one or more processing jobs 920 to be processed within the cluster. Responsive to identifying processing jobs 920, memory allocation system 910 identifies a quality of service for the jobs, which may be based on an administrator setting for the job, the amount of data that needs to be processed for the job, or any other quality of service setting. Once the quality of service is identified for each of the jobs, the jobs are then assigned to the virtual machines based on their individual quality of service. For example a job with a high quality of service will be assigned to high priority virtual machines 901, whereas a job with a low quality of service will be assigned to virtual machines 903.

Although illustrated in the present example with three levels of priority for the assignable virtual machines, it should be understood that any number of priority levels may exist with the virtual machines. Further, in some examples, new priority levels of virtual machines may be provisioned in response to the initiation of a particular new job.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of providing shared memory in a data processing cluster environment, the method comprising:
identifying one or more jobs to be processed in the data processing cluster environment;
determining a quality of service for each of the one or more jobs; and
allocating the shared memory for each of the one or more jobs in the data processing cluster environment based on the quality of service for each of the one or more jobs.

2. The method of claim 1 wherein the data processing cluster environment comprises one or more host computing devices executing one or more virtual machines.

3. The method of claim 2 wherein the shared memory comprises cache memory allocated on each of the one or more host computing devices.

4. The method of claim 3 wherein the cache memory for a first host computing device in the data processing cluster environment comprises memory accessible by at least one process on the first host computing device and a second process within at least one virtual machine executing on the first host computing device.

5. The method of claim 4 wherein the first process comprises a process executing outside of the at least one virtual machine.

6. The method of claim 1 wherein the one or more jobs comprise one or more distributed processing jobs.

7. The method of claim 1 wherein the quality of service for each of the one or more jobs comprises a service level assigned by an administrator.

8. The method of claim 1 wherein allocating the shared memory for each of the one or more jobs in the data processing cluster environment based on the quality of service for each of the one or more jobs comprises assigning the one or more jobs to virtual machines based on the quality of service for each of the one or more jobs, wherein the virtual machines are each allocated one portion of the shared memory.

9. The method of claim 8 wherein at least one of the portions of the shared memory allocated to the virtual machines is a different size than at least one other portion of the shared memory.

10. A computer apparatus to manage shared memory in a data processing cluster environment, the computer apparatus comprising:
processing instructions that direct a computing system, when executed by the computing system, to:
identify one or more jobs to be processed in the data processing cluster environment;
determine a quality of service for each of the one or more jobs; and
allocate the shared memory for each of the one or more jobs in the data processing cluster environment based on the quality of service for each of the one or more jobs.
one or more non-transitory computer readable media that store the processing instructions.

11. The computer apparatus of claim 10 wherein the data processing cluster environment comprises one or more host computing devices executing one or more virtual machines.

12. The computer apparatus of claim 11 wherein the shared memory comprises cache memory allocated on each of the one or more host computing devices.

13. The computer apparatus of claim 12 wherein the cache memory for a first host computing device in the data processing cluster environment comprises memory accessible by at least one process on the first host computing device and a second process within at least one virtual machine executing on the first host computing device.

14. The computer apparatus of claim 13 wherein the first process comprises a process executing outside of the at least one virtual machine.

15. The computer apparatus of claim 10 wherein the one or more jobs comprise one or more distributed processing jobs.

16. The computer apparatus of claim 10 wherein the quality of service for each of the one or more jobs comprises a service level assigned by an administrator.

17. The computer apparatus of claim 10 wherein the processing instructions to allocate the shared memory for each of the one or more jobs in the data processing cluster environment based on the quality of service for each of the one or more jobs direct the computing system to assign the one or more jobs to virtual machines based on the quality of service for each of the one or more jobs, wherein the virtual machines are each allocated with a portion of the shared memory.

18. The computer apparatus of claim 17 wherein at least one of the portions of the shared memory allocated to the virtual machines is a different size than at least one other portion of the shared memory.
